(19) United States
(12) Patent Application Publication
(10) Pub. No.: US 2009/0097289 A1
(43) Pub. Date: Apr. 16, 2009

(54) FEEDBACK COMMUNICATION TECHNIQUE FOR SWITCHED MODE POWER SUPPLY

(75) Inventor: Cornelis J.A. Schetters, Beuningen (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/914,221

(22) PCT Filed: May 9, 2006
(86) PCT No.: PCT/IB2006/051452

§ 371 Date: Oct. 30, 2008

(30) Foreign Application Priority Data
May 10, 2005 (EP) 05103902.2

(51) Int. Cl. H02M 7/04

(52) U.S. Cl. 363/84

(57) ABSTRACT

A power conversion circuit for a switched mode power supply (SMPS) 11 is arranged to be switchable between a normal mode of operation and a burst standby mode of operation. In an embodiment, the SMPS 11 comprises an AC/DC stage having a primary (input) side and a secondary (output) side of a transformer 12. A switched mode power stage has a controller 15 on the primary side for controlling the switching of power to the secondary side. The controller 15 has a control input 3 for receiving feedback signals from a feedback circuit 50 on the secondary side of the transformer 12. The SMPS 11 comprises an opto coupler 20 arranged to communicate to the control input 3 of the controller 15 a feedback signal which indicates the start and the end of a switching cycle in the burst mode. Advantageously, this allows the SMPS 11 to react quicker to loads applied when in the burst standby mode.

This invention relates to a switched mode power supply, a method of operating a switched mode power supply, a controller for switching a switched mode power supply, and a communication technique for switching between different modes of operation.

Switched mode power supplies (SMPS) are widely used to supply voltages in applications such as televisions, free-standing mains adaptors and the like. The applications typically operate in a number of modes, each activated when a different load is applied to the power supply. A standby mode is commonly adopted when, for example, a television is to remain powered but with reduced functions and reduced power consumption. In this mode the television will not output a picture or sound, but some circuitry remains active so as to be able to detect input from an associated remote control.

The relative power consumption of the SMPS and application when operating in such a standby mode is low. However, applications tend to operate for longer periods in this mode and consequently there is a continued desire to reduce the power consumption when operating in a low power mode.

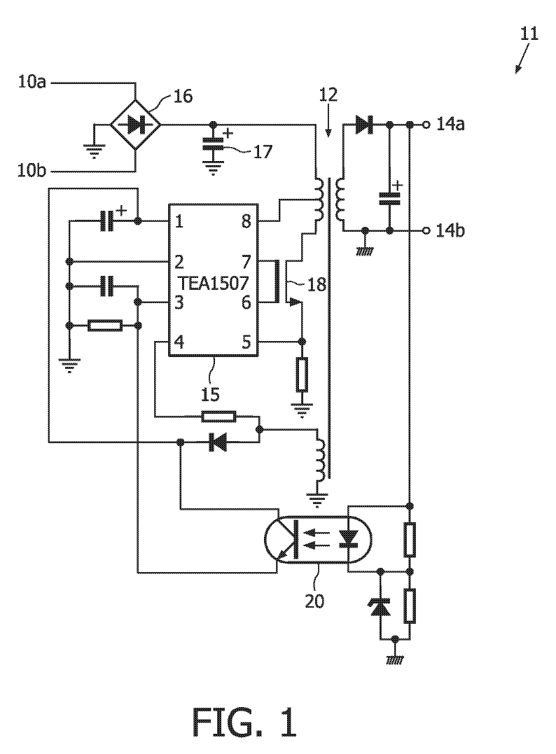

An example of a known SMPS circuit 11 is shown in FIG. 1. The circuit comprises two input terminals 10a,10b, a transformer 12 and two output terminals 14a,14b. The input A.C. voltage is converted to D.C. voltage by rectifier 16 and smoothed by capacitor 17. MOSFET 18, the gate voltage of which is Pulse Width Modulation (PWM) controlled by the connected controller IC 15, in this example a TEA1507 available from Philips Semiconductors, regulates the current through the primary winding of the transformer 12. The load is connected to the two output terminals 14a, 14b which are connected across the secondary winding of the transformer 12.

The output power is determined by high frequency switching of the current through the primary winding, regulated by the MOSFET 18. The average number of switching operations per unit time, and the current caused to flow in the transistor 18 in each switching operation, together determine the average power transmitted to the load.

In order to regulate the supply to the required output (output voltage and/or current), a feedback operation is employed to communicate e.g. the output voltage on the secondary side of the transformer 12 to the controller IC 15 on the primary side. For safety reasons the output of the SMPS circuit 11 is floating with respect to the input which is in general connected to the mains grid. For that reason an electrical isolation between the primary and secondary side of the transformer 12 is needed and achieved by using an opto coupler 20. This comprises an LED and a phototransistor. The current through the LED (I_{LED}) is proportional to the voltage across the output terminals 14a,14b, and therefore determines the brightness thereof. The light output from the LED is detected by the phototransistor which then sends a signal to the Ctrl input 3 of controller IC 15. The current flow through the primary winding of transformer 12 is then regulated by the controller IC 15 accordingly.

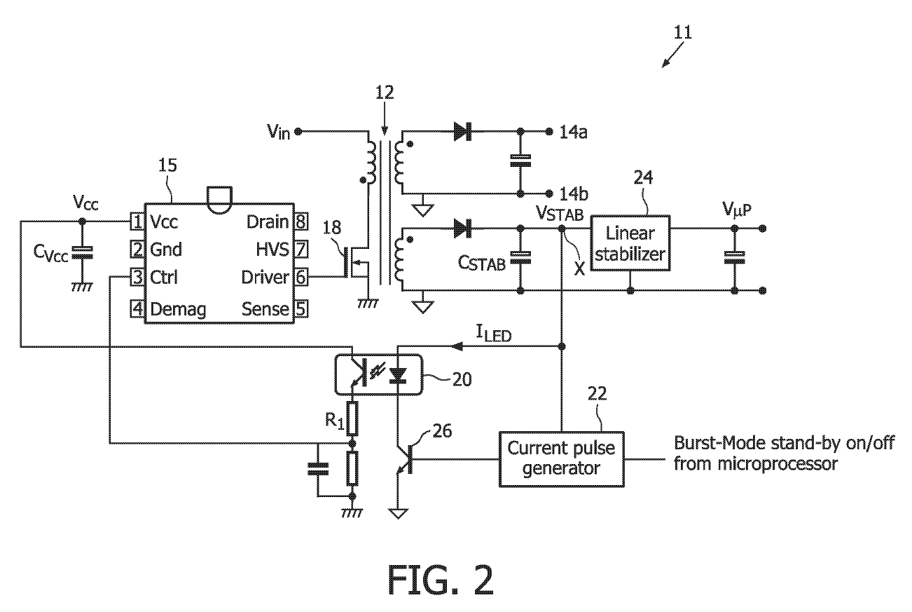

When the load is small the SMPS 11 can be made to operate in a low power mode so as to save power. One such known method is to provide a ‘burst mode’ wherein the periodic switching of the MOSFET 18 is interrupted so as to reduce the number of switching operations thereof. Therefore, in the ‘burst mode’ there are switching cycles comprising bursts of high frequency power pulses separated by periods in which there are no power pulses at all. This known technique, which is described in more detail below, is disclosed in the document “Data Sheet TEAL 507”, published by Philips Semiconductors on 5 Dec. 2000 and can be implemented by the circuit depicted in FIG. 2.

FIG. 2 shows a known SMPS circuit 11 which illustrates an arrangement in the basic burst mode configuration and includes features equivalent to the circuit of FIG. 1, which have like reference numerals. In addition to the features of the circuit of FIG. 1, and to provide the burst mode capability, the secondary side of the transformer 12 includes a buffer capacitor C_{STAB} connected in parallel across the secondary side of the transformer 12 in front of a linear stabilizer 24. A current pulse generator 22 is connected to a node X at voltage V_{STAB} before the input to the linear stabilizer 24 and switches a transistor 26 which controls the flow of current from the same node X through the opto coupler 20.

Burst mode is a cyclic mode of operation that can be used to reduce the power consumption below 1 W at stand-by. During burst mode the controller IC 15 is active (generating gate pulses to MOSFET 18) for only a short time and for a longer time inactive waiting for the next burst cycle. In the active period the energy (power) is transferred to the secondary side of transformer 12 and stored in the buffer capacitor C_{STAB} in front of the linear stabilizer 24 as described below. During the inactive period the load (e.g. a microprocessor, not shown) discharges this buffer capacitor C_{STAB}. In this mode the controller makes use of the so-called “safe-restart mode”.

For a more detailed description of one switching cycle in the burst mode (herein called “burst cycle”), three time intervals are defined:
t1 Discharge of V_{CC} when gate drive is active
t2 Discharge of V_{CC} when gate drive is inactive
t3 Charge of V_{CC} when gate drive is inactive

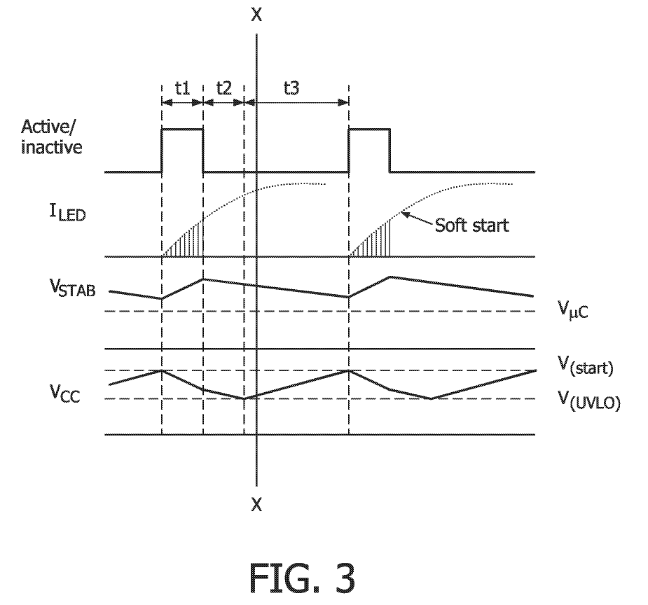

As the skilled person will recognise, V_{CC} is the supply voltage to controller IC 15, and is supplied to pin 1 thereof to switch the controller IC on and off. The controller IC 15 is switched on when V_{CC} is equal to a start voltage Vₛₜₐᵣₜ. A capacitor C_{Vcc} is connected between pin 1 and ground, which discharges linearly when the supply voltage to controller IC is switched off, thereby maintaining a linearly decreasing supply voltage V_{CC} to pin 1. When this supply voltage reaches a threshold called the “under voltage lock out” voltage V_{UVLO} the controller IC 15 switches off, according to the so-called safe-restart mode. FIG. 3 illustrates burst mode waveforms during these three time intervals, t1, t2 and t3.

During the first time interval, t1, controller IC 15 generates a gate pulse to MOSFET 18 which switches at high frequency, so that energy is transferred from the primary to the secondary side of transformer 12, which results in a ramp-up of the output voltage (V_{STAB}) in front of the linear stabilizer 24. When enough energy is stored in the capacitor C_{STAB} the controller IC 15 will be switched-off as follows.

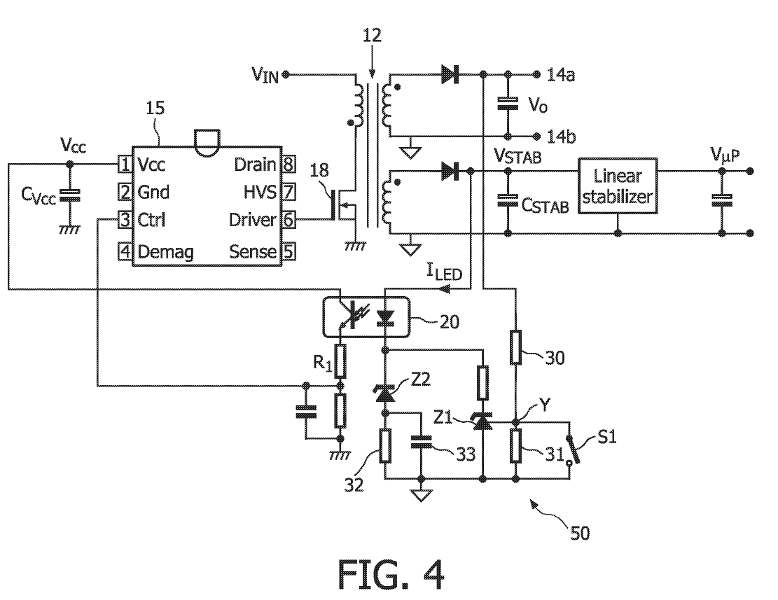

During the time interval t1, current pulses are generated at the secondary side of transformer 12 by the current pulse generator 22 switching its associated transistor 26 to allow current I_{LED} to flow into opto coupler 20. The pulses are transferred to the primary side via the opto coupler 20 and increase in magnitude as the buffer capacitor C_{STAB} is charged, as shown in FIG. 3. The controller 15 will disable the output driver (IC pin 6) (safe restart mode) when the current pulse on the primary side reaches a threshold level of 16 mA into the Ctrl pin (IC pin 3) of controller 15. Because of the large variation on the Current Transfer Ratio (CTR) of the opto coupler 20, a resistor R1 is placed in series to limit the current going into the Ctrl pin. Meanwhile the V_{CC} capacitor C_{VCC} is discharged but stays above the under voltage lock out voltage V_{UVLO} during this time interval (see FIG. 4).

During the second time interval, t2, the V_{CC} capacitor C_{VCC} is discharged to V_{UVLO}. The output voltage (V_{STAB}) will decrease depending on the load as buffer capacitor C_{STAB} discharges.

The third interval, t3, starts when the supply voltage from capacitor V_{CC} reaches the under voltage lock out voltage V_{UVLO} and the controller IC 15 switches off. An internal current source (not shown) then charges the V_{CC} capacitor C_{VCC}. Once the V_{CC} capacitor C_{VCC} is charged to the start-up voltage level Vₛₜₐᵣₜ the controller IC 15 is switched back on, the driver (IC pin 6) is activated and a new burst cycle is started.

With reference to FIG. 3, it can be seen that a ‘dead period’ exists between burst mode pulses (during time intervals t2 and t3), exemplified by the line marked X-X. If a load is applied to the output of the SMPS 11 during this period (for instance if the application is switched on from standby), the buffer capacitor C_{STAB} must drain so as to maintain the output voltage. Thus, in the conventional arrangement, capacitor C_{STAB} must be relatively large e.g. 4700 μF, which occupies valuable board space, thereby increasing the size of the device, and is relatively expensive.

It would be desirable to provide an improved SMPS which is insensitive to load changes at any point in time during a switching cycle of a burst mode of operation or the like, without using a large energy storage device.

According to one aspect of the present invention there is provided a power conversion circuit having a first mode of operation having switching cycles and a second, normal mode of operation, the power conversion circuit comprising: a switched mode power stage having input terminals on a primary side of a transformer for receiving power, output terminals on the secondary side of the transformer for supplying output power to a load, and a controller on the primary side of the transformer for controlling the switching of power from the primary side to the secondary side of the transformer; the power conversion circuit further comprising feedback circuitry, on the secondary side of the transformer, for providing a feedback signal to a control input of the controller, wherein the feedback signal indicates the end of a switching cycle in the first mode of operation.

By providing a feedback signal that indicates the end of a switching cycle in the first mode of operation, it is possible for the power conversion circuit to smoothly, and substantially immediately, transition to the second, normal mode of operation if a load is applied during a switching cycle.

In one embodiment, the switched mode power stage further comprises a buffer capacitor coupled in parallel across the secondary side of the transformer for storing charge in the first mode of operation, wherein the feedback circuitry provides a signal which indicates the end of a switching cycle in the first mode of operation in response to a drop in voltage across the buffer capacitor.

In another embodiment, the first mode of operation is a standby burst mode of operation and the second mode of operation is a normal mode of operation. Typically, and the feedback circuitry provides a feedback signal with indicates both the start and the end of a burst mode switching cycle.

Advantageously, this embodiment provides a system which not only provides for the communication of the start of a burst mode switching cycle in the standby mode to the controller circuit but also provides for the monitoring and communication of the end of a burst mode switching cycle. When implemented in an SMPS circuit, this enables a reduction in the size of the aforementioned buffer capacitor C_{STAB} on the output side thereof. In particular, if a load is applied to the output of the SMPS circuit during the burst mode switching cycle, the feedback circuitry provides a feedback signal indicating the (possibly early) end of the switching cycle. The normal mode of operation is then substantially immediately resumed, thus avoiding the need for a large buffer capacitor.

The beginning and end of the switching cycles in the first, standby mode of operation may be detected by monitoring the V_{STAB} voltage level. Preferably, the monitoring of the end of the switching cycle of the first, standby mode period can be done by providing means for detecting a minimum voltage V_{μC} on the capacitor C_{STAB} and providing a corresponding signal to the controller.

In one embodiment, the feedback circuitry is arranged to provide a feedback signal to the control input: to regulate the output voltage in the normal mode of operation, and to indicate the start and end of the burst mode switching cycle in the standby mode of operation, wherein the feedback signal indicating the end of the burst mode switching cycle initiates the start of switching of power from the primary side to the secondary side of the transformer.

In accordance with another aspect, the present invention provides a power conversion circuit arranged to be switchable between first and second modes of operation and comprising: a switched mode power stage having input terminals on a primary side of a transformer for receiving power, output terminals on a secondary side of the transformer for supplying output power to a load, and a mode monitoring input on the primary side of the transformer for receiving feedback signals to act on mode changes; the power conversion circuit comprising feedback circuitry arranged to supply to the mode monitoring input a feedback signal which indicates an operating status of the power conversion circuit.

In accordance with yet another aspect, the present invention provides an electronic device incorporating a power conversion circuit according to any one of the aforementioned aspects of the present invention.

In accordance with another aspect, the present invention provides a method for operating a power conversion circuit in a first mode of operation, the first mode of operation having switching cycles, the power conversion circuit comprising a switched mode power stage having input terminals on a primary side of a transformer for receiving power, output terminals on the secondary side of the transformer for supplying output power to a load, a controller on the primary side of the transformer for controlling the switching of power from the primary side to the secondary side of the transformer and feedback circuitry on the secondary side of the transformer, for providing a feedback signal to a control input of the controller dependent on a voltage output level (V_{STAB}) at a node on the secondary side of the transformer, the method comprising: providing a feedback signal at a first signal level in response to the feedback circuitry detecting a maximum voltage level at the node; in response to the feedback signal at the first signal level, stopping the switching of power from the primary side to the secondary side of the transformer; thereafter, providing a feedback signal at a second signal level; providing a feedback signal at a third signal level, in response to the feedback circuitry detecting a minimum voltage output level at the node, and in response to the feedback signal at the third signal level, starting the switching of power from the primary side to the secondary side of the transformer.

Thus, the present invention relates a power conversion circuit for a switched mode power supply that offers or permits improvements over the known devices. Various novel concepts, inventive concepts and specific embodiments are disclosed herein, particularly but not exclusively with reference to the accompanying drawings.

Further features and advantages of the present invention will become apparent from reading of the following detailed description of preferred embodiments, given by way of example only, and with reference to the accompanying drawings, in which:—

FIG. 1 shows a circuit arrangement of a known switched mode power supply (SMPS);

FIG. 2 shows a circuit arrangement of a known SMPS in basic burst mode configuration;

FIG. 3 shows burst mode signal waveforms for the circuit arrangement of FIG. 2;

FIG. 4 shows a circuit arrangement of an SMPS circuit in accordance with an embodiment of the present invention, and

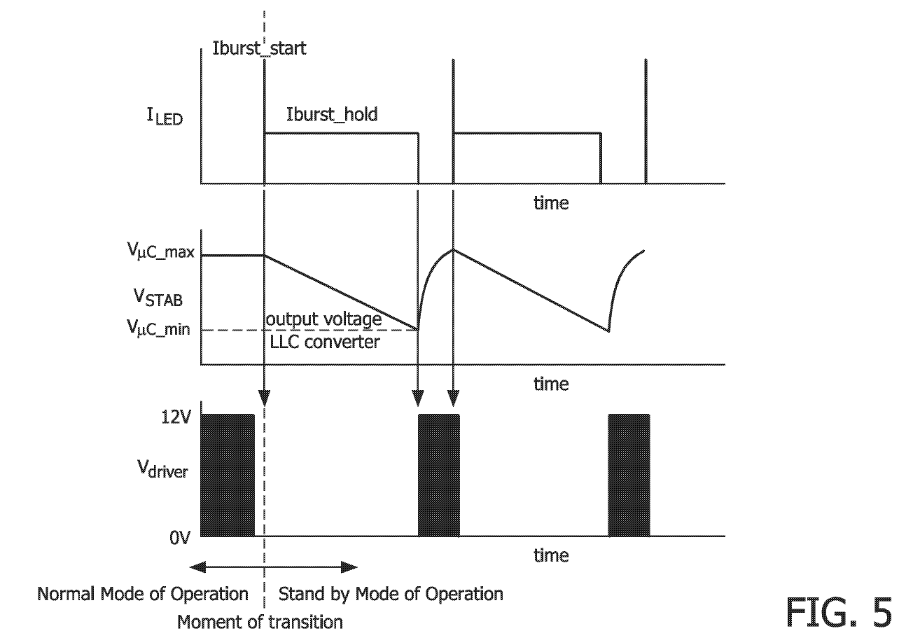

FIG. 5 shows example waveforms present in a SMPS circuit in accordance with the embodiment of the invention of FIG. 4.

Like components are given the same reference numerals in the different drawings.

With reference to FIGS. 2 and 3, which illustrate a known SMPS and associated waveforms, the start of a standby mode is detected by feedback circuitry which then supplies a signal to the controller IC 15 so that the input power can be switched from an operating mode to an off mode. A micro processor (not shown) provides a signal to current pulse generator 22 to a mode change input of the controller IC 15 (IC pin 3), which serves to switch the switched mode power stage into a standby mode by initiating a first burst of pulses of a burst cycle. As explained above, a problem exists that, whilst in this standby mode, there is a ‘dead period’ between burst pulses during which, if the application is switched to normal mode, the buffer capacitor C_{STAB} is drained in order to maintain the output to the required application. Thus, the size of the capacitor C_{STAB} must be sufficiently large for this purpose.

In accordance with an embodiment of the invention, unlike the known SMPS circuit of FIG. 2, the SMPS circuit is provided with feedback means arranged to supply to the controller 15 not only a signal which indicates the start of a burst cycle in the standby mode but also a signal that indicates the end of a burst cycle in the standby mode. The end of a burst cycle can occur during a transition from standby mode to normal mode, and thus the feedback signal can ensure a smooth transition from standby mode to normal mode, as will be appreciated from the following description.

The end of a burst standby mode can represent itself in two ways; either by the lack of initiation of new burst cycle (i.e. new burst pulses) and a smooth change over to normal mode, or by a sudden voltage drop on C_{STAB}. In accordance with a preferred embodiment of the present invention, a sudden drain on C_{STAB} is detected as indicating the end of a burst cycle in standby mode and this is communicated to the controller 15. The SMPS circuit then returns to normal operation by a smooth and substantially immediate transition between modes with no system reset. By monitoring for, and communicating, the end of a burst cycle in the standby mode, the system of the present invention enables an almost immediate switch from the standby mode of operation to the normal mode of operation upon application of a load during a burst cycle. In this way, the required output is more easily maintained with minimal drain on buffer capacitor C_{STAB}. Thus, the present invention may be implemented with a buffer capacitor C_{STAB} of reduced size in comparison to conventional arrangements.

FIG. 4 shows a SMPS circuit arrangement 11 in accordance with one embodiment of the present invention, having feedback circuitry 50 for normal and standby modes of operation. The feedback circuitry 50 comprises a switch S1 which determines the mode of operation of the SMPS circuit 11. When switch S1 is open, the SMPS circuit 11 operates in a normal mode, and when switch S1 is closed, the SMPS circuit 11 operates in a standby mode. Switch S1 is controlled by, for example, a microprocessor of the electronic device or other application in which the SMPS circuit 11 is incorporated.

The feedback circuitry 50 further comprises a pair of series connected resistors 30, 31, connected to the output line 14a in front of the capacitor between outputs 14a and 14b. Switch S1 is connected across resistor 31. Diode Z1 is connected to a node Y between resistors 30 and 31 and to the opto coupler 20 via a resistor. Finally, parallel-connected capacitor 33 and resistor 32 combination is also connected, via diode Z2, to the opto coupler 20, as shown in FIG. 4.

In normal mode of operation, switch S1 is open and the output voltage Vo is controlled by the feedback circuitry 50 in a conventional manner as explained above in relation to the circuit of FIG. 2, involving resistors 30 and 31, diode Z1 and opto coupler 20.

In standby mode of operation, when switch S1 is closed, a replica of the output voltage is no longer present across diode Z1, and no control of the output voltage is possible. Consequently, the output voltage Vo and, due to the coupled outputs of the transformer 12, V_{STAB} will rise. When V_{STAB} increases to the level that diode Z2 starts to conduct a current I_{LED} will start to flow through the opto coupler 20. For diode Z2 a zener diode is used in the preferred arrangement, although the skilled person will appreciate that various alternative arrangements (such as combinations of NPN's and zener diodes) may be used to implement the present invention.

Since closing S1 represents entering a standby mode and therefore a low output load condition the rise in Vo and therefore in V_{STAB} and I_{LED} will be steep leading to a pulsed current flowing through opto coupler 20. This pulse will be detected by the controller IC 15 on Ctrl pin input (pin 3) as being the start of a burst cycle and will switch off the driver pin 6, which drives the gate of MOSFET 18, of controller 15. Capacitor 33 in the feedback circuitry 50 improves the steepness and more or less defines the top level of the pulse. At the moment the controller 15 stops switching, Vo and, due to the transformer coupling, V_{STAB} will drop. Resistor 32 will discharge capacitor 33 in such a way that the voltage drop of capacitor 33 with respect to ground is faster then the voltage drop of V_{STAB} with respect to ground. Consequently, a mid level current through zener diode Z2 and opto coupler 20 remains, corresponding to I_{burst}_{_{—}}_{hold} in FIG. 5. Since the controller 15 is switched off, V_{STAB} will continue to drop as relatively low power is output to the load, and at a certain point in time diode Z2 will stop conducting (in theory when V_{Z2}=V_{STAB}−Vf_{LED}). No current will flow through opto coupler 20 and the controller 15 will detect this signal via Ctrl input (IC pin 3) and start operating again by driving the gate of MOSFET 18 for another burst pulse.

By maintaining this mid-level current level or offset level, I_{burst}_{_{—}}_{hold}, through opto coupler 20 between burst pulses in standby mode, it is possible to smoothly transition back to normal mode when a load is applied at the end of standby mode. In particular, during standby mode, as described above, switch S1 is closed and when I_{burst}_{_{—}}_{hold} drops to zero, a new burst pulse is initiated. However, in the case of a sudden load being applied, such as at the end of standby mode, I_{burst}_{_{—}}_{hold} will also drop (and switch S1 will be open—controlled by μP). Thus, if power is drawn from the outputs 14a, 14b by a high output load between burst pulses, the voltage Vo will fall, and likewise voltage V_{μC} on the buffer capacitor C_{STAB} will drop from a maximum level V_{μC}_{_{—}}ₘₐₓ to a minimum level V_{μC}_{_{—}}ₘᵢₙ (see FIG. 5), and the feedback current I_{LED} will drop from I_{burst}_{_{—}}_{hold} to zero. This current drop will be detected by the controller 15 on Ctrl input (pin 3), as described above, and the controller will switch on the MOSFET 18. Since the feedback circuit is now operating in normal mode, with switch S1 open, the controller 15 thus resumes the normal mode of operation.

Thus, referring to FIG. 5, the burst mode switching cycle starts (when switch S1 is closed) with feedback circuit 50 generating a burst pulse I_{LED}=I_{burst}_{_{—}}ₛₜₐᵣₜ through opto coupler 20 which is communicated to Ctrl pin (pin 3) of controller IC 15 which switches off the gate driver (pin 6) to MOSFET 18. The controller IC 15 thus stops the gate pulses and V_{driver}=0. The voltage V_{STAB} is a maximum level V_{μC}_{_{—}}ₘₐₓ denoting that buffer capacitor C_{STAB} is fully charged.

Immediately after the burst pulse the feedback circuit 50 continues to generate a mid level signal I_{burst}_{_{—}}_{hold} through opto coupler 20, which is similarly communicated to Ctrl pin of controller IC 15. During this time, the voltage driving the gate of MOSFET 18 is off (V_{driver}=0), and the voltage V_{STAB} drops as the buffer capacitor C_{STAB} is drained as output is provided to the load.

The feedback circuit 50 detects when the voltage V_{STAB} reaches the minimum level V_{μC}_{_{—}}ₘᵢₙ, and stops the current flow through opto coupler 20 (I_{LED}=0). This drop in the feedback signal I_{LED} through opto coupler 20 from I_{burst}_{_{—}}_{hold} to zero is communicated to Ctrl pin (pin 3) of controller IC 15 and signifies the end of the burst mode switching cycle. As explained above, the drop in voltage V_{STAB} to the minimum level V_{μC}_{_{—}}ₘᵢₙ may also occur in response to the application of a load, indicating the end of the standby mode, and this is likewise communicated to Ctrl pin (pin 3) of controller IC 15.

Between switching cycles, as shown in FIG. 5, I_{LED}=0, and the controller IC drives MOSFET 18 to transfer power to the secondary side of the transformer 12, and thus recharge buffer capacitor C_{STAB} so that V_{STAB} rises back to the maximum level V_{μC}_{_{—}}ₘₐₓ. At this stage, the transition to normal mode may occur. Specifically, if switch S1 is open, the feedback circuit 50 operates to provide to Ctrl pin of controller IC 15 a feedback signal indicating the output voltage Vo, allowing the regulation thereof by the controller IC 15.

Thus, in the illustrated embodiment, monitoring of the start and end of a burst cycle of the standby mode is achieved by the feedback circuit 50 detecting the maximum and minimum voltage levels V_{STAB} on the capacitor C_{STAB} of the SMPS circuit 11. Both these voltage levels V_{μC}_{_{—}}ₘₐₓ and V_{μC}_{_{—}}ₘᵢₙ are defined by the components of the feedback circuit 50 on the secondary side of the SMPS and, as the skilled person will appreciate, can therefore be tailored to the application in such a way the smallest value for capacitor C_{STAB} is obtained.

As the skilled person will appreciate, when the conventional burst mode technique of charging and discharging the Vcc capacitor is applied, the converter does not immediately resume operation when the burst hold signal drops from I_{burst}_{_{—}}_{hold} to zero. Rather, the Vcc capacitor must first be charged to the Vcc start-up voltage level before the converter actually starts. However, this delay is considerably shorter than in the prior art case (providing a shorter dead time and more importantly adaptive to the load). Nevertheless, the technique of applying the burst mode, using the feedback technique of the present invention, may be modified to reduce this delay. For example, if a technique were to be used in which Vcc does not drop to V_{UVLO} during burst, then when the burst hold signal drops the converter would immediately resumes normal operation. Again, and consequently, C_{STAB} may be minimised.

In contrast to known arrangements, three or more current levels I_{LED} are provided through the opto coupler 20, corresponding to a normal mode level, burst pulse level and an intermediate burst hold level. As the skilled person will appreciate, by providing one or more additional current levels, in accordance with the invention, it is possible to convey not only information concerning the mode of operation but other types of information, for example status updates relating to protection and safety features, which can be discriminated by the controller 15.

It will be appreciated that the power conversion circuit of the present invention has numerous advantages over the conventional SMPS circuit.

For example, by definition, the circuit provides for proper mode changes from normal mode of operation to standby and back. No system reset of hang up is possible.

Since the size of the capacitor C_{STAB} is not constrained, like the known circuit configuration, by the worst case condition of returning back to normal mode immediately after standby mode, the value of C_{STAB} may be reduced, thereby enabling cost reductions. For example, in a typical CRT-TV SMPS, the capacitor may be reduced from 3300 μF/16V to 68 μF/16V.

Moreover, less and adjustable voltage ripple adjustment is possible without increase of the buffer capacitor.

Burst mode frequency can be adjusted in an easy way and does not affect the other modes of operation.

Although the controller in the described embodiments takes the form of an integrated circuit (IC), its functions may equally be implemented in other forms.

As the skilled person will appreciate, the feedback circuit shown and described in the illustrated embodiment is just one example of many possible circuit configurations for providing for the intermediate burst hold current level and a signal change in response to a change in load at the end of a burst cycle which may correspond to the end of a standby period. Many other circuit arrangements for implementing the present invention are possible and contemplated.

Moreover, the I_{burst}_{_{—}}_{hold} current level does not need to be fixed to a solid DC level. Rather, it is possible to use any arbitrary fluctuating level between zero and the pulsed level, to provide an intermediate level that can be used for conveying discriminating information (in the described embodiment the information conveyed is burst start, burst end and normal mode of operation).

As will be clear to the skilled person, the present invention may be extended to communicate different kinds of feedback information, e.g. operating status can be communicated using the feedback technique.

In summary, there is provided a power conversion circuit which may be implemented in a switched mode power supply (SMPS). The circuit is arranged to be switchable between a normal mode of operation and a burst standby mode of operation. A switched mode power stage has a controller with a control input for receiving feedback signals. The circuit comprises an opto coupler arranged to supply to a controller a feedback signal from feedback circuitry which indicates the start and the end of a burst cycle in the standby mode. Advantageously, this allows the SMPS to react quicker to loads applied when in the burst standby mode, and avoids the need for a relatively large buffer capacitor to supply voltage between burst pulses. The SMPS may be incorporated in an electronic device which has a normal mode of operation and a standby mode of operation such as a television.

From reading the present disclosure, other variations and modifications will be apparent to the skilled person. Such variations and modifications may involve equivalent and other features which are already known in the art, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicant hereby gives notice that new claims may be formulated to such features and/or combinations of such features during the prosecution of the present application or of any further application derived therefrom.

1. A power conversion circuit having a first mode of operation having switching cycles and a second, normal mode of operation, the power conversion circuit comprising:
a switched mode power stage having input terminals on a primary side of a transformer for receiving power, output terminals on the secondary side of the transformer for supplying output power to a load, and a controller on the primary side of the transformer for controlling the switching of power from the primary side to the secondary side of the transformer;
the power conversion circuit further comprising feedback circuitry, on the secondary side of the transformer, for providing a feedback signal to a control input of the controller, wherein the feedback signal indicates the end of a switching cycle in the first mode of operation.

2. A power conversion circuit as claimed in claim 1, wherein the switched mode power stage further comprises a buffer capacitor coupled in parallel across the secondary side of the transformer for storing charge in the first mode of operation, wherein the feedback circuitry provides a signal which indicates the end of a switching cycle in the first mode of operation in response to a drop in voltage across the buffer capacitor.

3. A power conversion circuit as claimed in claim 1, wherein the first mode of operation is a standby burst mode of operation and the second mode of operation is a normal mode of operation, and the feedback circuitry provides a feedback signal with indicates both the start and the end of a burst mode switching cycle.

4. A power conversion circuit as claimed in claim 3, wherein the feedback circuitry is arranged to provide a feedback signal to the control input:
to regulate the output voltage in the normal mode of operation, and
to indicate the start and end of the burst mode switching cycle in the standby mode of operation,
wherein the feedback signal indicating the end of the burst mode switching cycle initiates the start of switching of power from the primary side to the secondary side of the transformer.

5. A power conversion circuit as claimed in claim 4, wherein, in a burst mode switching cycle in the standby mode of operation, the feedback circuitry is configured to initially provide a feedback signal at a first signal level to the control input to indicate the start of the burst mode switching cycle, and thereafter to provide a feedback signal at a second signal level to the control input until a buffer capacitor on the secondary side of the transformer is discharged to a predetermined minimum level.

6. A power conversion circuit as claimed in claim 5, wherein, when the buffer capacitor is discharged to the predetermined minimum level, the feedback circuitry is configured to provide a feedback signal at a third signal level to the control input, the third signal level indicating the end of a burst mode switching cycle.

7. A power conversion circuit as claimed in claims 5 wherein, the feedback circuitry includes a switch, the operation of the switch changing the mode of operation of the power conversion circuit, wherein in response to the operation of the switch to change from standby mode to normal mode, the feedback circuitry is configures to detect a sudden discharge of buffer capacitor to the predetermined minimum level, and to provide by the feedback signal at the third signal level, thereby initiating the start of switching of power from the primary side to the secondary side of the transformer in the normal mode of operation.

8. A power conversion circuit as claimed in claim 7, wherein the third signal is level is less that the second signal level and the second signal level is less that the first signal level.

9. A power conversion circuit as claimed in claim 1, wherein: the feedback circuitry is configured to supply to the control input a feedback signal at a fourth signal level, the fourth signal level indicating an operating status of the power conversion circuit.

10. An electronic device incorporating a power conversion circuit as claimed in claim 1.

11. A method for operating a power conversion circuit in a first mode of operation, the first mode of operation having switching cycles, the power conversion circuit comprising a switched mode power stage having input terminals on a primary side of a transformer for receiving power, output terminals on the secondary side of the transformer for supplying output power to a load, a controller on the primary side of the transformer for controlling the switching of power from the primary side to the secondary side of the transformer, and feedback circuitry on the secondary side of the transformer, for providing a feedback signal to a control input of the controller dependent on a voltage output level at a node on the secondary side of the transformer, the method comprising:
providing a feedback signal at a first signal level in response to the feedback circuitry detecting a maximum voltage level at the node; in response to the feedback signal at the first signal level, stopping the switching of power from the primary side to the secondary side of the transformer;
thereafter, providing a feedback signal at a second signal level;
providing a feedback signal at a third signal level, in response to the feedback circuitry detecting a minimum voltage output level at the node, and
in response to the feedback signal at the third signal level, starting the switching of power from the primary side to the secondary side of the transformer.
